(19) United States
(12) Patent Application Publication
(10) Pub. No.: US 2014/0297121 A1
(43) Pub. Date: Oct. 2, 2014

(54) SMART PARKING ASSIST SYSTEM AND CONTROL METHOD THEREOF

(71) Applicants: Kia Motors Corporation, Seoul (KR); Hyundai Motor Company, Seoul (KR)

(72) Inventor: Kwang Won SEO, Gunpo-si (KR)

(73) Assignees: KIA MOTORS CORPORATION, Seoul (KR); HYUNDAI MOTOR COMPANY, Seoul (KR)

(21) Appl. No.: 14/139,676

(22) Filed: Dec. 23, 2013

(30) Foreign Application Priority Data
Mar. 29, 2013 (KR) 10-2013-0034859

(51) Int. Cl. B62D 15/02

(52) U.S. Cl. CPC B62D 15/0285
USPC 701/41

(57) ABSTRACT

A method of controlling a smart parking assist system includes: determining whether an obstacle presents in a start direction; releasing a start steering assist using the smart parking assist system when the obstacle presents in the start direction; and reporting a corresponding situation to a driver, thereby preventing a collision between a vehicle and the obstacle in a start process when the driver accidentally selects the start direction.

### CROSS-REFERENCE TO RELATED APPLICATION

This application claims the benefit of priority to Korean Patent Application No. 10-2013-0034859 filed in the Korean Intellectual Property Office on Mar. 29, 2013, the entire contents of which are incorporated herein by reference.

### TECHNICAL FIELD

The present disclosure relates to a smart parking assist system (SPAS) applied to a vehicle and a control method thereof. More particularly, the present disclosure relates to a SPAS capable of preventing collision between a vehicle and an obstacle when a driver accidentally selects a start direction of the vehicle in a case where a parked vehicle starts and a control method thereof.

### BACKGROUND

In a vehicle according to the related art, a smart parking assist system (SPAS) has been applied for the purpose of convenient driving, particularly, parking.

The SPAS detects and recognizes a parking space having a predetermined size using a sensor or a camera and steers a vehicle to the parking space.

That is, the SPAS recognizes the parking space through the sensor or the camera mounted at front, rear, and lateral sides of the vehicle, and actively controls an electronically controlled power steering system (EPS) to automatically assist the vehicle to be parked at the recognized parking space so that a driver conveniently parks the vehicle only by a brake and a transmission operation.

The SPAS according to the related art includes a parking mode selection switch to be selected by the driver, a motor driven power steering (MDPS) for automatic steering, and a smart wheel sensor detecting a steering angle and speed of a vehicle wheel. An ultrasonic wave sensor or a camera detects and recognizes a parking space, and a driver reporting unit reports a parking or start direction to the driver through a display or sound. An electronic control unit (ECU) detects the parking or start direction, the parking space, a steering state of the vehicle wheel through the parking mode selection switch, the ultrasonic wave sensor, and the smart wheel sensor, and controls the MDPS to assist automatic steering.

When starting the parked vehicle using the SPAS according to the related art, a free space in front of and behind the vehicle is measured using ultrasonic wave sensors mounted at the front and rear sides of the vehicle, and a heading angle of the vehicle is steered in the start direction selected by the driver via a start direction selection switch.

During the start process, the vehicle may repeatedly move forward and backward according to the size of the free space. During the forward and backward repeating process, the heading angle of the vehicle is continuously steered to the selected start direction, and only the transmission operation and the brake operation are necessary. When a front bumper reaches a heading angle to avoid a front obstacle, the SPAS terminates.

However, during the start process according to the related art using the foregoing SPAS, if the driver accidentally selects the start direction to continue automatic steering assist when the obstacle presents in the start direction, the vehicle may collide with the obstacle due to the selection of the start direction by the driver during the start process.

The above information disclosed in this Background section is only for enhancement of understanding of the background of the disclosure, and therefore it may contain information that does not form the prior art that is already known in this country to a person of ordinary skill in the art.

### SUMMARY

The present disclosure provides a smart parking assist system and a control method thereof capable of preventing a start vehicle from colliding with an obstacle during a start process by stopping an automatic steering assist operation when a driver accidentally selects a start direction.

According to an embodiment of the present disclosure, a method of controlling a smart parking assist system includes: determining whether an obstacle exists in a start direction; and releasing a start steering assist using the smart parking assist system when the obstacle exists in the start direction.

The releasing the start steering assist may include releasing the start steering assist using the smart parking assist system when the obstacle exists in the start direction for more than a predetermined time.

The method may further include continuously performing the start steering assist using the smart parking assist system if the obstacle is not detected in the start direction for more than the predetermined time.

The method may further include reporting a corresponding situation to a driver through an alarm sound or a display when the obstacle exists in the start direction.

The method may further include: operating a start function using the smart parking assist system; selecting the start direction; and detecting a distance between a start vehicle and another vehicle or an obstacle present in a forward direction or a backward direction of the start vehicle.

The method may further include: releasing the start steering assist using the smart parking assist system when the distance between the start vehicle and the another vehicle or the obstacle present in the forward direction or the backward direction of the start vehicle is less than or equal to a predetermined distance; and reporting a corresponding situation to a driver through an alarm sound or a display.

The start direction may be selected by a continuous operation of a selection switch.

According to another embodiment of the present disclosure, a smart parking assist system includes a controller performing the control method, distance detecting sensors mounted at a front and a rear side of a vehicle, respectively, and an obstacle detecting sensor mounted at a lateral side of the vehicle.

The distance detecting sensors and the obstacle detecting sensor may include an ultrasonic wave sensor.

According to an exemplary embodiment of the present disclosure of the smart parking assistant system and a control method thereof, when a driver accidentally selects a start direction in a direction of an obstacle to start a parked vehicle using the SPAS the vehicle can be prevented from colliding with the obstacle during a start process by releasing the SPAS, thereby protecting the vehicle and passengers.

In addition to release of the SPAS, the start direction is reported to the driver through a display or an alarm, thereby providing convenient driving to the driver.

### BRIEF DESCRIPTION OF THE DRAWINGS

FIG. 1 is a flowchart illustrating a method of controlling a smart parking assist system (SPAS) according to an exemplary embodiment of the present disclosure.

### DETAILED DESCRIPTION

Hereinafter, an exemplary embodiment of the present disclosure will be described in detail with reference to the accompanying drawing.

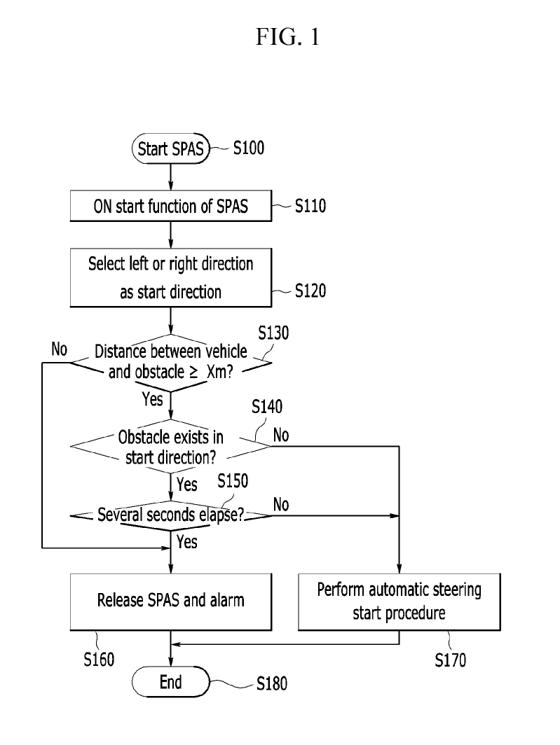

Referring to FIG. 1, a method of controlling a smart parking assist system (SPAS) according to an exemplary embodiment of the present disclosure, sequentially performs following steps when the SPAS is executed.

A driver executes the SPAS in order to start a parked vehicle (S100). The driver then executes a start function of the SPAS (S110).

The driver then checks left and right directions, determines which direction to start the parked vehicle t, and selects a proper direction as the start direction of the vehicle (S120).

The left or right direction may be selected as the start direction of the vehicle by continuously pressing a left/right start direction selection switch included in the SPAS.

When pressing the left/right start direction selection switch, the left direction may be selected as the start direction, and by continuously pressing the switch, the right direction may be selected as the start direction.

Once the start direction is selected by the driver, a controller of the SPAC detects a distance between the start vehicle and another vehicle or an obstacle presented in a front side or a rear side of the vehicle using a distance detecting sensor, such as an ultrasonic wave sensor mounted at the front side and the rear side of the vehicle (S130).

If the detected distance is less than a predetermined distance Xm, since the parked vehicle cannot start, the controller releases the SPAC assist and reports a corresponding situation to the driver through a suitable alarm device, for example, an alarm sound, or through a display on a cluster (S160).

If the detected distance is greater than the predetermined distance Xm, since the parked vehicle ca start, the controller determines whether an obstacle presents in the start direction selected by the driver (S140).

The obstacle may be detected through, for example, the ultrasonic wave sensor which is an obstacle sensor mounted at a lateral side of the vehicle.

If the obstacle is a wall existing in the start direction, the present disclosure may prevent a collision with the wall.

The obstacle is continuously detected for more than a predetermined time (S150).

If the obstacle is not continuously detected for more than the predetermined time, the controller performs an automatic steering start process so that the driver may start the vehicle using the SPAS (S170).

Detecting the obstacle continuously prevents erroneous detection when a moving object such as walkers temporarily presents in the start direction.

If the obstacle is continuously detected for more than a predetermined time, the controller releases the SPAS assist and reports the corresponding situation to the driver through the alarm device (S160).

Accordingly, if the obstacle such as the wall exists in the start direction as the driver accidentally selects the start direction, the SPAS assist stops to efficiently prevent the start vehicle from colliding with the obstacle, thereby preventing damage to the vehicle and protecting passengers from the collision.

As mentioned above, an exemplary embodiment of the present disclosure is disclosed herein, but the present disclosure is not limited to the disclosed embodiments, but, on the contrary, is intended to cover various modifications and equivalent arrangements included within the appended claims and the detailed description and the accompanying drawing of the present disclosure.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A method of controlling a smart parking assist system, the method comprising:
determining whether an obstacle exists in a start direction; and
releasing a start steering assist using the smart parking assist system when the obstacle exists in the start direction.

2. The method of claim 1, wherein the releasing the start steering assist comprises releasing the start steering assist using the smart parking assist system when the obstacle exists in the start direction for more than a predetermined time.

3. The method of claim 1, further comprising continuously performing the start steering assist using the smart parking assist system if the obstacle is not detected in the start direction for more than a predetermined time.

4. The method of claim 1, further comprising reporting a corresponding situation to a driver through an alarm sound or a display when the obstacle exists in the start direction.

5. The method of claim 1, further comprising:
operating a start function using the smart parking assist system;
selecting the start direction; and
detecting a distance between a start vehicle and another vehicle or an obstacle present in a forward or a backward direction of the start vehicle.

6. The method of claim 5, further comprising:
releasing the start steering assist using the smart parking assist system when the distance between the start vehicle and the another vehicle or the obstacle present in the forward or the backward direction of the start vehicle is less than or equal to a predetermined distance; and
reporting a corresponding situation to a driver through an alarm sound or a display.

7. The method of claim 5, wherein the start direction is selected by a continuous operation of a selection switch.

8. A smart parking assist system comprising:
a controller performing the control method of claim 1;
distance detecting sensors mounted in a front side and a rear side of a vehicle, respectively; and
an obstacle detecting sensor mounted at a lateral side of the vehicle.

9. The smart parking assist system of claim 8, wherein the distance detecting sensors and the obstacle detecting sensor comprise an ultrasonic wave sensor.
